(19) United States
(12) Patent Application Publication
(10) Pub. No.: US 2013/0100640 A1
(43) Pub. Date: Apr. 25, 2013

(54) U-SHAPED LED ENERGY SAVING LAMP

(71) Applicant: Marcus Zhang, Yuyao (CN)

(72) Inventor: Marcus Zhang, Yuyao (CN)

(21) Appl. No.: 13/378,668

(22) PCT Filed: Oct. 25, 2011
(86) PCT No.: PCT/CN11/81297

§ 371 Date: Dec. 15, 2011

(30) Foreign Application Priority Data
Oct. 24, 2011 (CN) 201110326614.5

(51) Int. Cl. F21V 9/16; F21V 29/00; F21V 1/00

(52) U.S. Cl. 362/84; 362/235; 362/294

(57) ABSTRACT

The present patent application discloses a U-shaped LED energy saving lamp, comprising a lamp base; a drive shell that has a drive provided therein is arranged on the lamp base, the drive shell being made of heat-conducting plastic embedded with metal or simply made of heat-conducting plastic material; the drive shell is engaged with the U-shaped lampshade, inside of which a substrate electrically connected with the drive is provided, and the substrate has LED assemblies mounted thereon. The LED lamp according to the present patent application not only effectively realizes that the LED lamp irradiates with light in an angle of larger than 330 degree but also evenly irradiates without the problem of glaring, and the heat dispersion performance thereof is excellent.

### FIELD OF THE PATENT APPLICATION

The present patent application relates to illumination technical field, more particularly, to a U-shaped LED energy saving lamp.

### BACKGROUND

In the prior art, LED light source will become an idealized energy saving light source. The advantage of LED light source is its high illuminating efficiency. However, only approximately 20-30% of total electric energy can be transformed into light energy for the current LED lamps during the energy transformation. In addition to the portion of electric energy which is transformed into light energy, the rest portion of them is transformed into heat energy. Thus, there is a need for LED lamp products to be properly designed in consideration of heat dispersion. Most of LED lamp products are directly powered under high voltage, thus the products must meet the requirements of electrical high-voltage safety. Additionally, LED lamps in the prior art have serious problems of uneven lighting and glaring. All of above mentioned technical problems are urgently to be solved for a person skilled in the art.

### SUMMARY

In order to address such above technical problems, the present patent application provides a U-shaped LED energy saving lamp that is capable of overcoming the defects of bad heat dispersion and easy glaring of LED lamps in the prior art.

In order to solve the above problems, the technical solution employed by the present patent application is as follows: a U-shaped LED energy saving lamp, comprising a lamp base; a drive shell that has a drive provided therein is arranged on the lamp base, the drive shell being made of heat-conducting plastic embedded with metal or simply made of heat-conducting plastic material; the drive shell is engaged with the U-shaped lampshade, inside of which a substrate electrically connected with the drive is provided, and the substrate has LED assemblies mounted thereon.

According to the above technical solution, the U-shaped lampshade is made of optical light-transmitting material having high light transmission coefficient and diffusion material or additionally coating of yellow phosphor mixture is applied outside or inside of the U-shaped lampshade, or alternatively the yellow phosphor mixture as well as acrylic (also referred to as PMMA), PC or polycarbonate is directly molded into U-shaped lampshade; the yellow phosphor mixture does not contact with LED assemblies.

According to the above technical solution, the substrate is made of materials having high heat conduction coefficient such as aluminum or ceramics.

According to the above technical solution, the LED assemblies are constituted by a plurality of low-powered LEDs or bar-shaped COB LEDs or blue light LEDs.

In comparison with the prior art, the present patent application has the following advantages:
1. The LED lamp may not only efficiently irradiate with light in an angle of larger than 330 degree but also evenly irradiate without the problem of glaring;
2. The LED assemblies may not directly contact with yellow phosphor, thereby reducing the color temperature of the LED assemblies and the phosphor mixture, improving stabilization of the amount of light flux, the color temperature and the electrical parameters of the whole system, and at the same time, decreasing the light attenuation and increasing the light flux maintenance ratio;
3. Since the substrate is made of materials having high heat conduction coefficient such as aluminum or ceramics and the heat radiated by LED lamp is transferred to the drive shell, the heat dispersion performance is excellent.

### BRIEF DESCRIPTIONS OF THE DRAWINGS

FIG. 1 is an exploded view of a U-shaped LED energy saving lamp according to the present patent application.

In the FIGURE, reference numeral 1 indicates a lamp base; reference numeral 2 indicates a drive shell; reference numeral 3 indicates a U-shaped lampshade; reference numeral 4 indicates a substrate; reference numeral 5 indicates LED assemblies.

### DETAILED DESCRIPTION

The details of the present patent application are set forth in the accompanying drawings and the embodiments below. It should be understood that the following embodiment is used for the illustrative purpose rather than the limitation of the scope of the patent application.

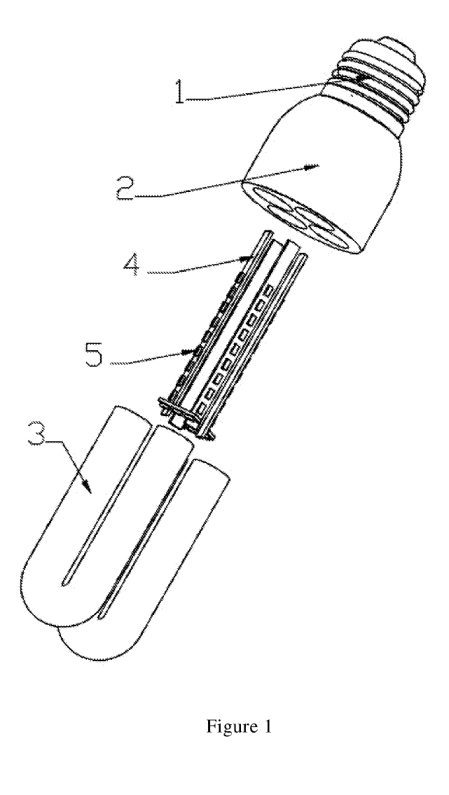

As shown in FIG. 1, a U-shaped LED energy saving lamp comprises a spiral lamp base 1 connected with power supply commercially available; a drive shell 2 that has a drive provided therein is arranged on the lamp base 1. The drive shell 2 is made of heat-conducting plastic embedded with metal or simply made of heat-conducting plastic material that has excellent heat dispersion effect. The drive shell 2 is engaged with U-shaped lampshade 3, inside of which a substrate 4 electrically connected with the drive is provided, and the substrate 4 is encapsulated within the drive shell 2 and the U-shaped lampshade 3. The substrate 4 with LED assemblies 5 mounted thereon is in a long-stripped shape and the width of the substrate 4 is less than the inner diameter of the U-shaped lampshade 3.

The U-shaped lampshade 3 is made of optical light-transmitting material having high light transmission coefficient and diffusion material or additionally coating of yellow phosphor mixture is applied outside or inside of the U-shaped lampshade, or alternatively the yellow phosphor mixture as well as acrylic, PC or polycarbonate is directly molded into U-shaped lampshade 3. The yellow phosphor mixture does not contact with LED assemblies 5.

The substrate 4 is made of materials having high heat conduction coefficient such as aluminum or ceramics.

The LED assemblies 5 are constituted by a plurality of low-powered LEDs or bar-shaped COB LEDs or blue light LEDs.

There is a need to illustrate that it is optional to apply yellow phosphor to the U-shaped lampshade 3 when using the LED lamp.

When the present patent application is in use, there are two ways for the LED lamp to achieve the effect of giving out white light evenly: firstly, the LED giving out white light irradiates light through the U-shaped lampshade without yellow phosphor applied; secondly, the blue light emitted by the blue light LED activates the yellow phosphor applied on the U-shaped lampshade to give out soft white light directly; the yellow phosphor on the U-shaped lampshade can be formed by one time.

The LED lamp according to the present patent application not only effectively realizes that the LED lamp irradiates with light in an angle of larger than 330 degree but also evenly irradiates without the problem of glaring. Moreover, since the substrate is made of aluminum or ceramics that have relatively high heat conduction coefficient and the heat radiated by LED lamp is transferred to the drive shell, the heat dispersion performance of LED lamp according to the present patent application is excellent.

A detailed description of the present patent application described above is disclosed with reference to the preferred embodiment of the present patent application. It will be apparent to ordinary person skilled in the art that various improvements and modifications can be made to the present patent application without departing from the technical principle of the present patent application. Those improvements and modifications should also be regarded as protection scope of the present patent application.

We claim:

1. A U-shaped LED energy saving lamp, comprises a lamp base, wherein a drive shell that has a drive provided therein is arranged on the lamp base, the drive shell being made of heat-conducting plastic embedded with metal or simply made of heat-conducting plastic material; the drive shell is engaged with the U-shaped lampshade, inside of which a substrate electrically connected with the drive is provided, and the substrate has LED assemblies mounted thereon.

2. The U-shaped LED energy saving lamp according to claim 1, wherein the U-shaped lampshade is made of optical light-transmitting material having high light transmission coefficient and diffusion material or additionally coating of yellow phosphor mixture is applied outside or inside of the U-shaped lampshade, or the yellow phosphor mixture as well as acrylic and polycarbonate is directly molded into U-shaped lampshade; the yellow phosphor mixture does not contact with LED assemblies.

3. The U-shaped LED energy saving lamp according to claim 1, wherein the substrate is made of aluminum or ceramics materials having high heat conduction coefficient.

4. The U-shaped LED energy saving lamp according to claim 1, wherein the LED assemblies are constituted by a plurality of low-powered LEDs, bar-shaped COB LEDs or blue light LEDs.
